(19) United States
(12) Patent Application Publication
(10) Pub. No.: US 2015/0019238 A1
(43) Pub. Date: Jan. 15, 2015

(54) PRESCRIPTION/MEDICATION MONITORING AND FRAUD DETECTION SYSTEM

(71) Applicant: Verizon Patent and Licensing Inc., Basking Ridge, NJ (US)

(72) Inventor: Michelle FELT, Randolph, NJ (US)

(21) Appl. No.: 13/942,359

(22) Filed: Jul. 15, 2013

(51) Int. Cl. G06F 19/00; G06K 19/06

(52) U.S. Cl. CPC G06F 19/3475; G06F 19/322; G06K 19/06037
USPC 705/2

(57) ABSTRACT

A device may receive information regarding a prescription for a patient from a device of a medical personnel member and generate prescription information using the information regarding the prescription. The device may transmit the prescription information to a device of a medication provider, and a user device of the patient. The device may transmit a notification indicating that the prescription information has been transmitted to the device of the medication provider and the user device. The notification may be transmitted to the device of the medical personnel member, the user device, and a device associated with an insurance company of the patient. The device may determine whether prescription fraud has been detected and may transmit another notification when the prescription fraud is detected. The other notification may indicate that the prescription fraud has been detected.

### BACKGROUND

Prescriptions may be issued to obtain medication to treat various medical conditions. However, prescriptions may be subject to several problems including fraud that may be committed by various parties (e.g., patients, medication providers such as pharmacies, and/or medical personnel such as physicians). As a result, medication, identified by the prescriptions, may be subject to illegal use and/or illegal sale.

### BRIEF DESCRIPTION OF DRAWINGS

FIGS. 1A-1C are diagrams of an overview of an implementation described herein;

FIG. 2 is a diagram of an example environment in which systems and/or methods described herein may be implemented;

FIG. 3 is a diagram of example components of one or more devices of FIG. 2;

FIGS. 4A and 4B are diagrams of example data structures;

FIGS. 5A and 5B are flow charts of an example process for monitoring prescriptions and detecting prescription fraud;

FIG. 6 is a flow chart of an example process for monitoring prescriptions and detecting prescription fraud; and

FIG. 7A-7C are diagrams of an example of the process described in FIGS. 5A, 5B, and 6.

### DETAILED DESCRIPTION OF PREFERRED EMBODIMENTS

The following detailed description refers to the accompanying drawings. The same reference numbers in different drawings may identify the same or similar elements.

Systems and/or methods described herein may monitor the issuance of prescriptions and the issuance of medications to detect fraud related to prescriptions and medications.

As used herein, a medical personnel member may include any entity that provides medical services including, for example, a physician, a nurse, a medical student, military medical corpsman, and/or the like. As used herein, a medication provider may include any entity that provides medication including, for example, a pharmacy, a mail order pharmacy, a pharmacist, and/or the like. As used herein, “prescription” may include a medical prescription. As used herein, medication may include, for example, a drug, a medicine, and/or the like.

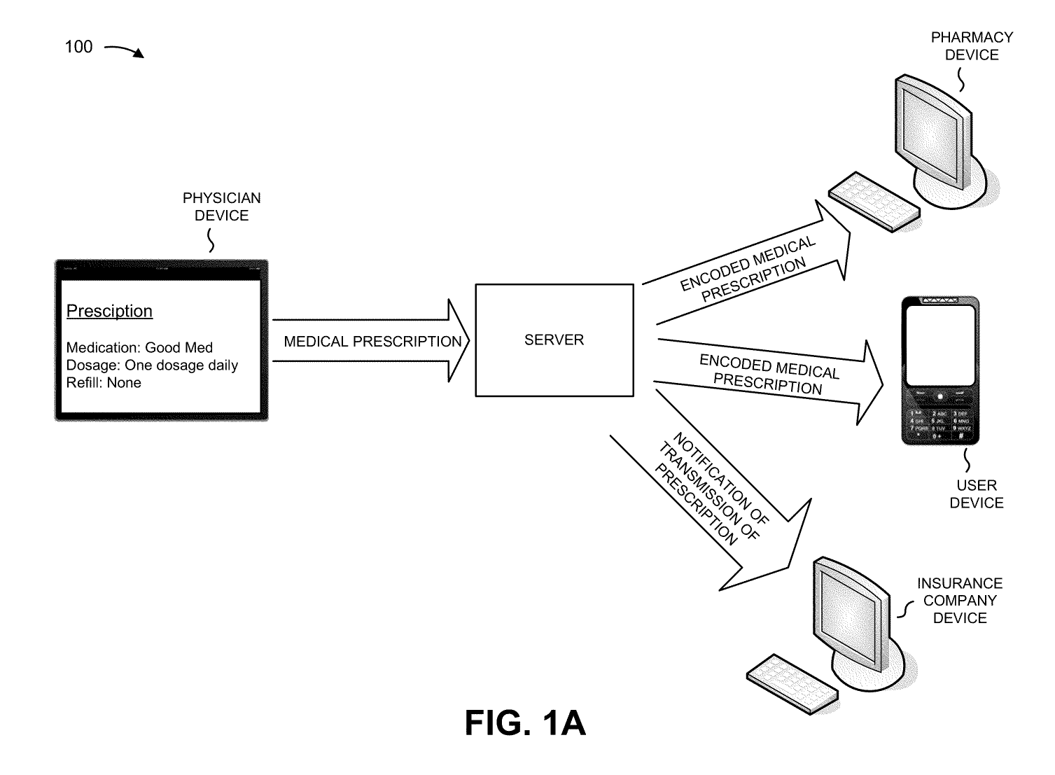

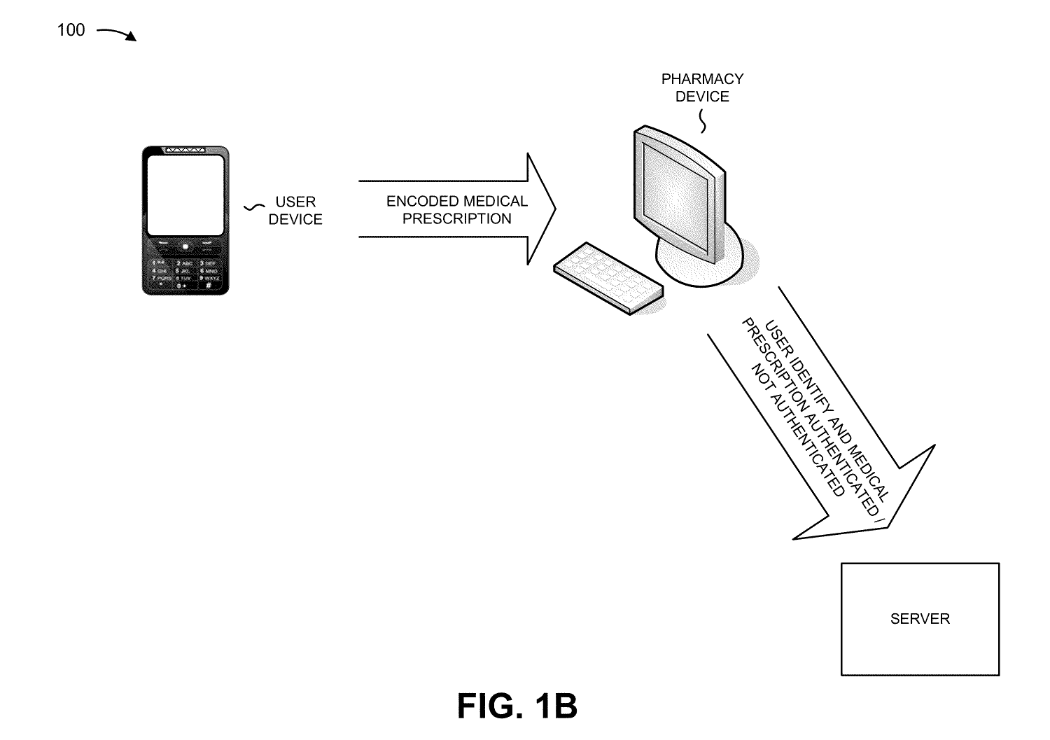

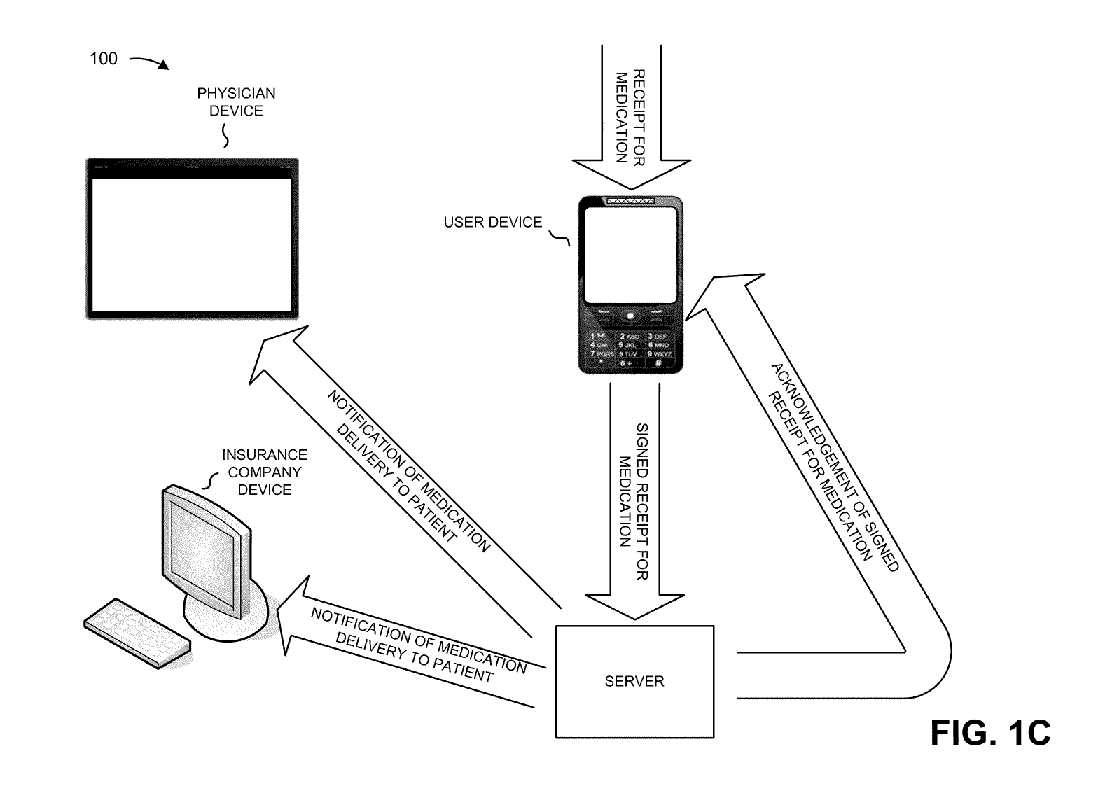

FIGS. 1A-1C are diagrams of an overview of an implementation described herein. In FIG. 1A, assume, for example, that a user (e.g., a patient) has visited an office of a medical personnel member (e.g., a physician) regarding a medical condition. Further, assume that the physician has accessed (e.g., by logging in to) a server (e.g., a server that monitors prescriptions and medication to detect a prescription fraud) to obtain a prescription history of the patient. The physician may provide, to the server, information regarding a prescription for the patient's medical condition using a device of the physician (displayed as a tablet computer). For example, after reviewing the prescription history, the physician may provide the information regarding the prescription via an interface provided by the server. The server may encode the information regarding the prescription and other information identifying the patient. The server may also transmit the encoded prescription (e.g., encoded as a quick response (“QR”) code) to a user device (displayed as a smartphone) of the patient and to a device of a medication provider (e.g., a pharmacy) and may transmit a notification to a device of an insurance company of the patient to indicate that the prescription has been issued to the patient.

In FIG. 1B, assume, for example, that the patient has arrived at the pharmacy to obtain a medication identified by the prescription. Further, assume a device of the pharmacy has scanned the QR code from the user device to obtain the prescription. Further, assume the device of the pharmacy has received, from the server, the QR code along with information that may be used to authenticate the identity of the patient and authenticate the prescription (obtained from the user device). The device of the pharmacy may compare the prescription (obtained from the user device) to the prescription (received from the server) to authenticate the identity of the patient and to authenticate the prescription obtained from the user device. The device of the pharmacy may transmit, to the server, information indicating whether the identity of the patient and the prescription have been authenticated. Additionally, the pharmacy may provide the medication to the patient based on the identity of the patient and the prescription being authenticated, and may cause the user device to receive a receipt for the medication provided to the patient.

In FIG. 1C, assume, for example, that the identity of the patient and the prescription have been authenticated and that the medication has been provided to the patient. Accordingly, the user device of the patient may receive a receipt for the medication. The patient may electronically sign the receipt and transmit the electronically signed receipt to the server. The server may then transmit, to the patient, a notification acknowledging that the electronically signed receipt has been received and may transmit, to the physician and the insurance company of the patient, a notification indicating that the medication has been provided to the patient.

Accordingly, systems and methods, as described herein, may monitor the issuance of prescriptions and the issuance of medications to detect problems, typically related to paper-based prescription, such as fraud related to prescriptions and medications (e.g., which may be committed by a medical personnel member, a medication provider, a patient, etc.).

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encoding and anonymization techniques for particularly sensitive information.

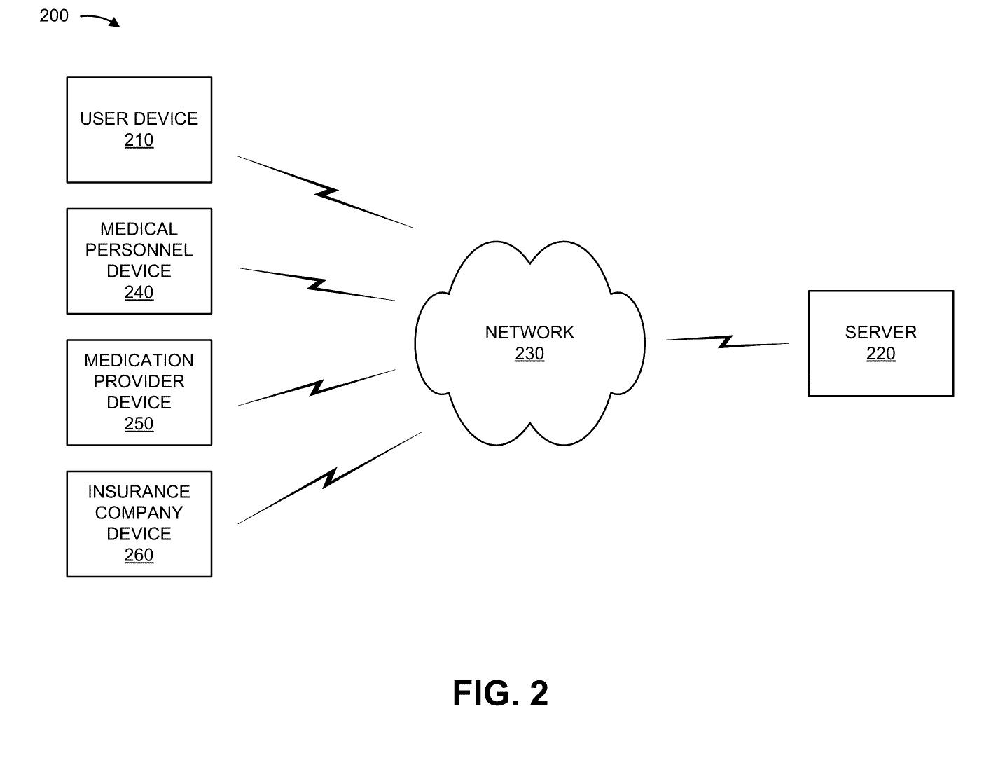

FIG. 2 is a diagram of an example environment 200 in which systems and/or methods described herein may be implemented. Environment 200 may include a user device 210, a server 220, a network 230, a medical personnel member device 240, a medication provider device 250, and an insurance company device 260.

User device 210 may include one or more devices that are capable of receiving information regarding prescriptions. For example, user device 210 may include a personal digital assistant (PDA) (e.g., that include a radio telephone, a pager, Internet/intranet access, etc.), a tablet computer, a smart phone, a laptop, a gaming device, and/or a personal computer.

Server 220 may include one or more server devices. In some implementations, server 220 may receive, encode, store, and transmit information regarding prescriptions, as described herein. In some implementations, server 220 may be implemented as a cloud resource.

Network 230 may include one or more wired and/or wireless networks. For example, network 230 may include a cellular network, a public land mobile network (“PLMN”), a local area network (“LAN”), a wide area network (“WAN”), a metropolitan area network (“MAN”), a telephone network (e.g., the Public Switched Telephone Network (“PSTN”)), an ad hoc network, an intranet, the Internet, a fiber optic-based network, and/or a combination of these or other types of networks.

Medical personnel device 240 may include one or more devices that are capable of receiving and providing information regarding prescriptions. For example, medical personnel device 240 may include a personal digital assistant (PDA) (e.g., that include a radio telephone, a pager, Internet/intranet access, etc.), a tablet computer, a smart phone, a laptop, a gaming device, and/or a personal computer.

Medication provider device 250 may include one or more devices that are capable of receiving information regarding prescriptions and providing notifications associated with the information regarding the prescriptions. For example, medication provider device 240 may include a personal digital assistant (PDA) (e.g., that include a radio telephone, a pager, Internet/intranet access, etc.), a tablet computer, a smart phone, a laptop, a gaming device, and/or a personal computer.

Insurance company device 260 may include one or more devices that are capable of receiving information regarding prescriptions. For example, insurance company device 260 may include a personal computer, a laptop, a tablet computer, a personal digital assistant (PDA) (e.g., that include a radio telephone, a pager, Internet/intranet access, etc.), and/or a smart phone. In some implementations, insurance company device 260 may include one or more server devices.

The quantity of devices and/or networks, illustrated in FIG. 2, is provided for explanatory purposes only. In some implementations, there may be additional devices and/or networks; fewer devices and/or networks; different devices and/or networks; or differently arranged devices and/or networks than illustrated in FIG. 2. In some implementations, one or more of the devices of environment 200 may perform one or more functions described as being performed by another one or more of the devices of environment 200. Devices of environment 200 may interconnect via wired connections, wireless connections, or a combination of wired and wireless connections.

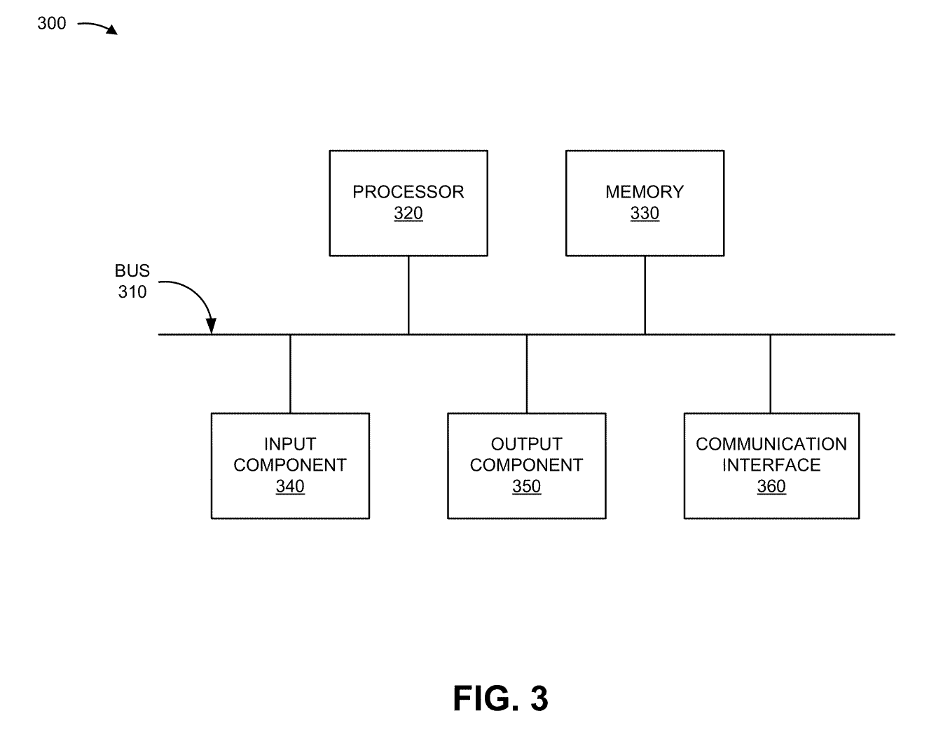

FIG. 3 is a diagram of example components of a device 300. Device 300 may correspond to user device 210, server 220, medical personnel device 240, medication provider device 250, and/or insurance company device 260. Additionally, or alternatively, each of user device 210, server 220, medical personnel device 240, medication provider device 250, and/or insurance company device 260 may include one or more devices 300 and/or one or more components of device 300. As illustrated in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing logic (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a camera, a microphone, a switch, etc.). Output component 350 may include a component that outputs information from device 300 (e.g., a display, an audio speaker, one or more light-emitting diodes (“LEDs”), etc.).

Communication interface 360 may include a transceiver-like component, such as a transceiver and/or a separate receiver and transmitter that enables device 300 to communicate with other devices, such as via a wired connection, a wireless connection, or a combination of wired and wireless connections. For example, a communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

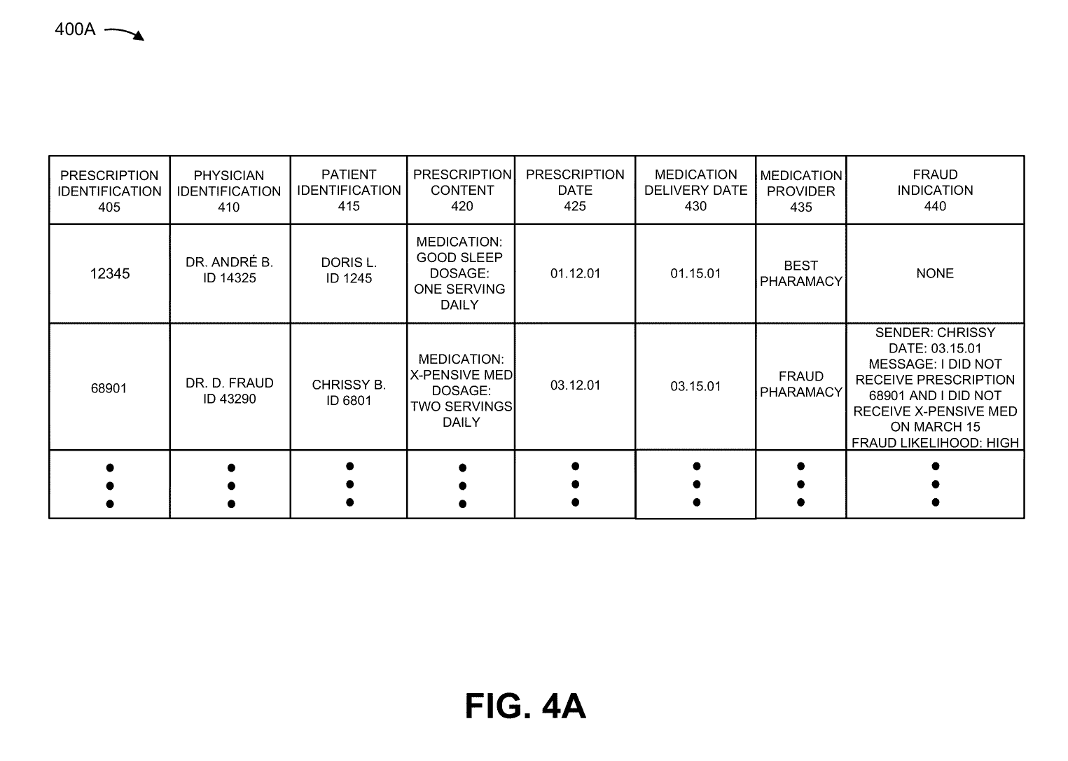

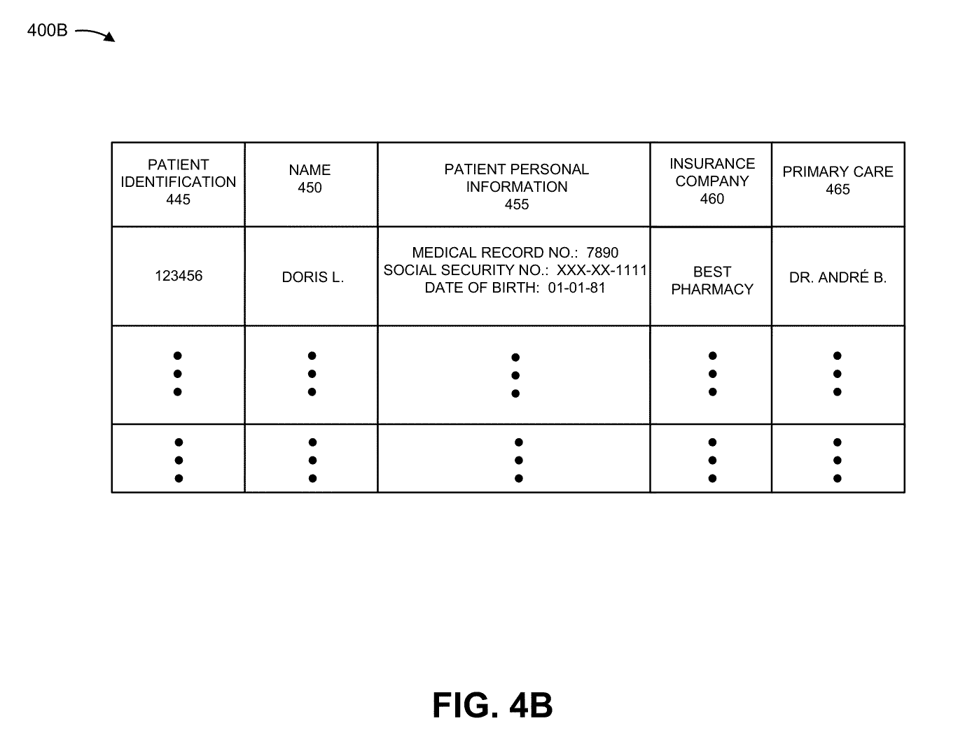

FIGS. 4A and 4B are example data structures 400A and 400B that store information that may be used to monitor prescriptions and medications and may be used to detect possible prescription fraud and medication fraud. In some implementations, server 220 may store a portion of or an entirety of data structure 400A and/or data structure 400B. In some implementations, data structure 400A and/or data structure 400B may be implemented as a cloud resource in conjunction with server 220. In some implementations, data structure 400A and/or data structure 400B may be stored in memory, associated with another device or a group of devices, separate from, or in combination, with memory associated with server 220. In some implementations, a portion of or an entirety of the information stored in data structures 400A and/or 400B may be provided by one or more devices including user device 210, server 220, medical personnel device 240, medication provider device 250, and/or insurance company device 260.

As shown in FIG. 4A, data structure 400A may include a group of fields, such as, for example, prescription identification field 405, physician identification field 410, patient identification field 415, prescription content field 420, prescription date field 425, medication delivery date field 430, medication provider information field 435, and fraud indication field 440.

Prescription identification field 405 may store information that uniquely identifies a prescription. For example, the information may include one or more characters that uniquely identify the prescription.

Physician identification field 410 may store information that uniquely identifies a physician. For example, the information may include one or more characters that uniquely identify the physician. Additionally, or alternatively, the information may include a first name of the physician, a last name of the physician, and/or other information that uniquely identifies the physician, such as contact information of the physician. The contact information may include an e-mail address, an office telephone number, a facsimile (“fax”) number, a mobile telephone number, and/or the like.

Patient identification field 415 may store information that uniquely identifies a patient. For example, the information may include one or more characters that uniquely identify the patient. Additionally, or alternatively, the information may include a first name of the patient, a last name of the patient, and/or other information that identifies the patient, such as contact information of the patient. The contact information may include an e-mail address, an office telephone number, a fax number, a mobile telephone number, and/or the like.

Prescription content field 420 may store information relating to the prescription. For example, the information may include information identifying medication, information a dosage of the medication, information identifying a quantity of refills of the prescription, information identifying a quantity of the medication, information identifying a period of time for taking the medication, and/or the like. Additionally, or alternatively, the information may include information identifying a diagnosis of the medical condition of the patient. Additionally, or alternatively, the information may include information identifying a next medical personnel appointment of the patient. The information identifying the next medical personnel appointment of the patient may include a date of the next medical personnel appointment, a time of the next medical personnel appointment, and/or the like.

Prescription date field 425 may store information that identifies a date and/or a time associated with a prescription. For example, prescription date field 430 may store information that identifies a date and/or time when prescription information identifying the prescription was provided to the patient. Additionally, or alternatively, prescription date field 430 may store information that identifies a date and/or time when the prescription information was generated by server 220. In some implementations, the date and/or time may be provided in different date and/or time formats.

Medication delivery date field 430 may store information that identifies a date and/or time when medication was provided to the patient by a medication provider. Additionally, or alternatively, medication delivery date field 430 may store information that identifies a date and/or time when a signed receipt for the medication was received. In some implementations, the date and/or time may be provided in different date and/or time formats.

Medication provider information field 435 may store information that uniquely identifies a medication provider. For example, the information may include one or more characters that uniquely identify the medication provider. Additionally, or alternatively, the information may include a name of the medication provider and contact information of the medication provider. The contact information may include an e-mail address, an office telephone number, a fax number, and/or the like.

Fraud indication field 440 may store information that indicates whether a potential fraud has been detected for the prescription. The information may include information identifying a sender of the information, a date and/or a time the information was received from the sender, and/or data indicating why the sender transmitted the information. For example, the data may be received from a physician and may indicate that the physician did not issue the prescription identified in the notification, indicate that a prescription was issued by the physician but the medication, the dosage, the refill of the prescription was different, and/or other information indicating that the patient may be attempting to commit fraud or may be a victim of fraud. Additionally, or alternatively, the data may be received from a patient and may indicate that the patient has not been examined by the physician, identified in the notification, indicate that the patient has not received a prescription for which a notification was received by the patient, other information indicating that the physician may be attempting to commit fraud or may be a victim of fraud.

In some implementations, data structure 400A may also include information indicating a likelihood of fraud for the prescription. For example, fraud indication field 440 may also store the information indicating the likelihood of fraud for the prescription. In some implementations, the information indicating the likelihood of fraud for the prescription may be stored in another field of data structure 400A. In some implementations, the information indicating the likelihood of fraud may include a level of the likelihood of fraud for the prescription. For example, the level of the likelihood of fraud for the prescription may correspond to a value that may range from a value indicating a low likelihood of fraud (e.g., relative a threshold of likelihood of fraud) to a value indicating a high likelihood of fraud (e.g., relative the threshold of likelihood of fraud). In some implementations, the value may be a numerical value. For example, the information indicating the likelihood of fraud may include a value from 0 (indicating a low or lowest likelihood of fraud) to 10 (indicating a high or highest likelihood of fraud). In some implementations, the value may be textual information. For example, the textual information may indicate “low likelihood of fraud,” “medium likelihood of fraud,” “high likelihood of fraud,” etc.

In some implementations, the level of the likelihood of fraud may be determined (e.g., by server 220) based on different factors. For example, the level of the likelihood of fraud may be based on a quantity of times potential fraud has been detected for the medical personnel member that issued the prescription and/or for the patient that received the prescription. By way of example, the level of the likelihood of fraud may increase as the quantity of times potential fraud has been detected (e.g., for the medical personnel member and/or for the patient) increases. Additionally, or alternatively, the level of the likelihood of fraud may be based on whether an indication, that the medical personnel member did not issue the prescription, has been received (e.g., from the medical personnel member). Additionally, or alternatively, the level of the likelihood of fraud may be based on whether an indication, that the patient did not receive the prescription or did not receive the medication, has been received (e.g., from the patient). Additionally, or alternatively, the level of the likelihood of fraud may be based on a period of time between similar prescriptions and a typical period of time for refilling the prescriptions (e.g., a difference between the period of time and the typical period of time).

By way of example, the level of the likelihood of fraud may be high when the period of time between the prescriptions is a few days (e.g., three days) while the typical period of time for refilling the prescriptions is several weeks. Conversely, the level of the likelihood of fraud may be low when the medication, identified in the prescription that was issued first, was not provided to the patient. Similarly, the level of the likelihood of fraud may be low when the period of time between the prescriptions is a week while the typical period of time is ten days.

In some implementations, each factor may be assigned a different weight when determining the level of the likelihood of fraud. For example, an indication that the medical personnel member did not issue the prescription or an indication that the patient did not receive the medication may be assigned a weight that is higher than a weight assigned to the quantity of times potential fraud has been detected. In some implementations, the weight assigned to each factor may be configured by an entity (e.g., a system administrator) associated with server 220.

For example, as shown in FIG. 4A, prescription 12345 was issued by Doctor André B. to Doris L. on Jan. 12, 2001. Doctor André B. prescribed the medication Good Sleep with a dosage of one serving daily. As also shown in FIG. 4A, the medication Good Sleep was provided to Doris L., on Jan. 15, 2001, by Best Pharmacy.

As shown in FIG. 4A, prescription 68901 was allegedly issued by Doctor D. Fraud to Chrissy B. on Mar. 12, 2001. Doctor D. Fraud prescribed the medication X-Pensive Med with a dosage of two servings daily. As also shown in FIG. 4A, the medication X-Pensive Med was allegedly provided to Chrissy B., on Mar. 15, 2001, by Fraud Pharmacy. As also shown in FIG. 4A, an indication of fraud was received from Chrissy B. and indicated that Chrissy B. did not receive prescription 68901 and did not receive X-Pensive Med. As also shown in FIG. 4A, the level of the likelihood of fraud is identified as high.

As shown in FIG. 4B, data structure 400B may include a group of fields, such as, for example, patient identification field 445, patient name field 450, patient personal information field 455, insurance company field 460, and primary care field 465.

Patient identification field 445 may store information that uniquely identifies a patient. For example, the information may include one or more characters that uniquely identify the patient, such as a unique identification number.

Patient name field 410 may store information that identifies a name of the patient. For example, the information may include may include a first name of the patient, a last name of the patient, and/or the like.

Patient personal information field 455 may store information that identifies personal information of the patient. For example, the information may include a medical record number, a date of birth, a portion of or an entirety of a social security number, information regarding existing medical conditions (e.g., allergies) and/or prior medical conditions, information regarding current medications and/or previous medications, other information that uniquely identifies the patient, and/or the like. Additionally, or alternatively, the information may include a password of the patient, a personal identification number (“PIN”) of the patient, biometric information of the patient, information relating to an image of a face of the patient, and/or any other type of information that may used to authenticate an identity of the patient. The biometric information may include information of the patient that may used to perform voice verification of the patient, face recognition of the patient, eye (e.g., retinal or iris) recognition of the patient, fingerprint recognition of the patient, and/or the like. Additionally, or alternatively, the information may include contact information of the patient. The contact information of the patient may include a telephone number (e.g., an office telephone number, a mobile telephone number, etc.), a fax number, an e-mail address, and/or the like. Additionally, or alternatively, the information may include information identifying one or more devices of the patient (e.g., information identifying user device 210.).

Insurance company field 460 may store information that uniquely identifies an insurance company of a patient. For example, the information may include one or more characters that uniquely identify the insurance company. Additionally, or alternatively, the information may include a name of the insurance company and contact information of the insurance company. The contact information of the insurance company may include an e-mail address, an office telephone number, a fax number, and/or the like.

Primary care field 465 may store information that uniquely identifies a primary care physician of a patient. For example, the information may include one or more characters that uniquely identify the primary care physician. Additionally, or alternatively, the information may include a name of the primary care physician and contact information of the primary care physician. The contact information of the primary care physician may include an e-mail address, an office telephone number, a fax number, and/or the like.

For example, as shown in FIG. 4B, the information regarding patient Doris L. includes her patient identification number, her medical record number, a portion of her social security number, her date of birth, information identifying her insurance company, and information identifying her primary care physician Doctor André B.

In some implementations, data structure 400B may store information indicating whether potential prescription fraud, with respect to a patient, has been received. For example, the information may indicate that the patient that has been a potential victim of potential prescription fraud. Additionally, or alternatively, the information may indicate that the patient has attempted to commit or has committed potential prescription fraud.

While FIGS. 4A and 4B show example fields of data structures 400A and 400B, in some implementations, data structures 400A and 400B may include different fields, additional fields, fewer fields, or differently arranged fields than the example fields depicted in FIGS. 4A and 4B.

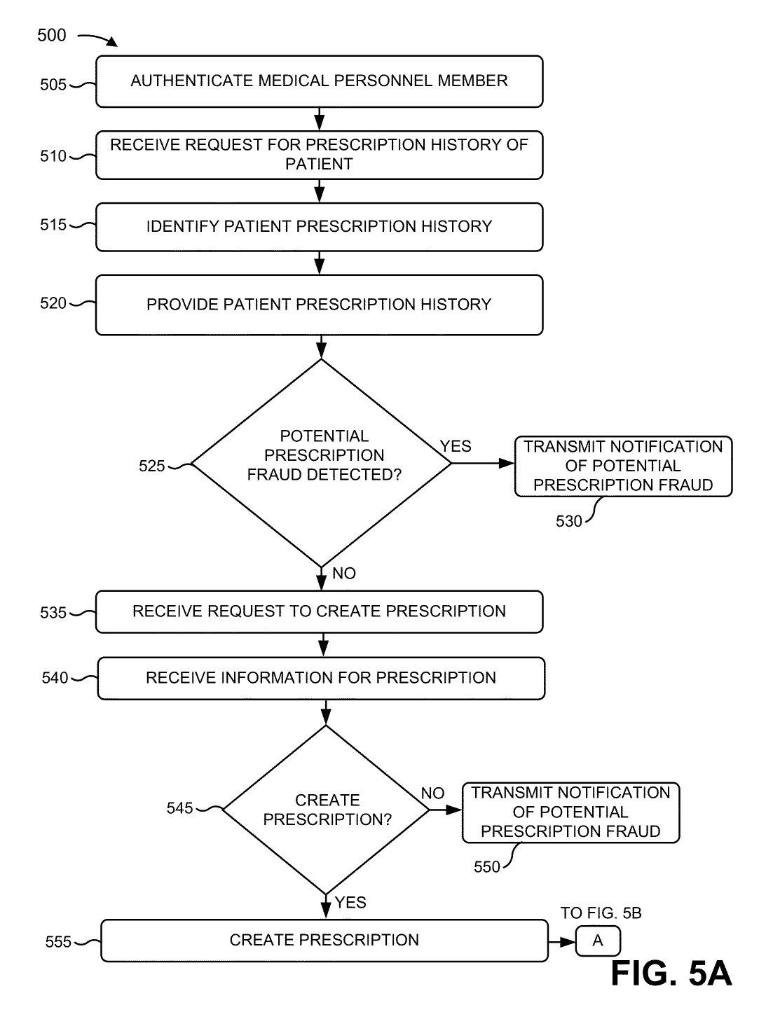

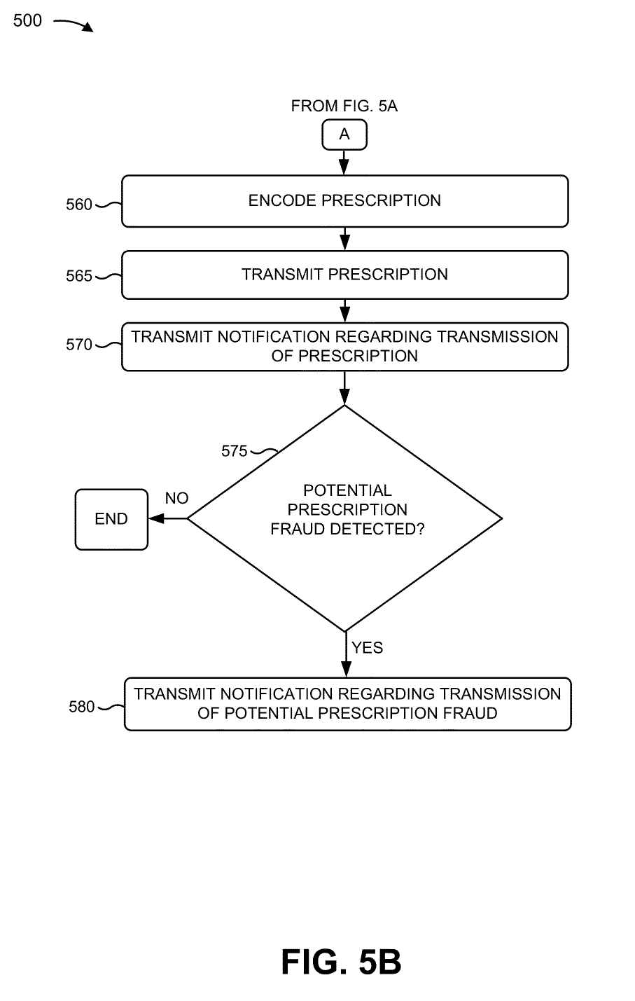

FIGS. 5A and 5B are flowcharts of an example process 500 for monitoring the issuance of prescriptions and the issuance of medications and detecting fraud related to prescriptions and medications. In some implementations, process 500 may be performed by server 220. In some implementations, one or more blocks of process 500 may be performed by one or more devices (e.g., medical personnel device 240) instead of, or possibly in conjunction with, server 220.

Process 500 may include authenticating a medical personnel member (block 505, FIG. 5A). For example, server 220 may receive information identifying the medical personnel member and authenticate the medical personnel member based on the information identifying the medical personnel member. In some implementations, server 220 may provide, to the medical personnel member via medical personnel device 240, an interface that may enable the medical personnel member to log in to server 220 prior to issuing a prescription. For example, server 220 may provide a graphical user interface to medical personnel device 240 that may enable the medical personnel member to enter a username and a password to access server 220. By way of example, server 220 may receive the username and the password and authenticate the medical personnel member based on the username and the password.

Process 500 may include receiving a request for a prescription history of a patient (block 510). For example, server 220 may receive, from medical personnel device 240, information identifying a patient and a request for the prescription history of the patient. The information identifying the patient may include a name of the patient, a medical record of the patient, a social security number of the patient, and/or other types of information that uniquely identifies the patient. Additionally, or alternatively, the information identifying the patient may include information identifying a next medical personnel appointment of the patient.

In some implementations, medical personnel device 240 may obtain the information identifying the patient from user device 210 (e.g., via a messaging service message, email, Near field communication (NFC), QR code or other short-range or network-based communication) and may transmit the information identifying the patient to server 220 along with the request for the prescription history via the same or other type of communication. For example, user device 210 may present the information identifying the patient via a display of user device 210, and medical personnel device 240 may obtain the information identifying the patient from user device 210 and may transmit the information identifying the patient to server 220 along with the request for the prescription history. By way of example, user device 210 may present the information identifying the patient as encoded information (e.g., a QR code). Medical personnel device 240 may read the encoded information from user device 210 and decode the encoded information prior to transmission to server 220. In some implementations, medical personnel device 240 may transmit the encoded information to server 220 and server 220 may decode the encoded information.

In some implementations, medical personnel device 240 may obtain the information identifying the patient from user device 210 and the information identifying the patient may be inputted by the medical personnel member for submission to server 220. For example, server 220 may provide an interface (e.g., a graphical user interface) to medical personnel device 240 and server 220 may receive the information identifying the patient, inputted by the medical personnel member using medical personnel device 240, via the interface.

In some implementations, the information identifying the patient and the encoded information may have been generated by server 220 and provided to user device 210 by server 220 prior to receiving the request for the prescription history of the patient.

In some implementations, medical personnel device 240 may obtain information identifying user device 210 from user device 210 (e.g., via a messaging service message, email, Near field communication (NFC), QR code or other short-range or network-based communication) and may transmit the information identifying user device 210 to server 220 along with the request for the prescription history via the same or other type of communication. As such, the information identifying the patient may not be obtained by medical personnel device 240. The information identifying user device 210 may include a mobile identification number (MIN), a mobile directory number (MDN), an electronic serial number (ESN), a mobile equipment identity (MEID), International Mobile Station Equipment Identity (IMEI), etc.

Process 500 may include identifying the prescription history of the patient (block 515). For example, server 220 may identify the prescription history of the patient using the information identifying the patient and/or the information identifying user device 210. In some implementations, server 220 may search a data structure using the information identifying the patient and/or using the information identifying user device 210, to identify the patient prescription history. For example, server 220 may search data structure 400A using the name of the patient, the medical record of the patient, the social security number of the patient, and/or other information included in the information identifying the patient. Information identifying prescriptions and medications that have been issued to the patient may be identified as results of searching data structure 400A.

Process 500 may include providing the prescription history of the patient (block 520). For example, server 220 may provide the prescription history of the patient to medical personnel device 240. In some implementations, server 220 may provide, to medical personnel device 240, an interface that includes the prescription history of the patient. For example, server 220 may provide, via the interface, the information identifying the prescriptions and the medications that have been issued to the patient. The information identifying the prescriptions and the medications may include information identifying a date and/or a time when each prescription was issued, information identifying a medical personnel member that issued the prescription, information identifying a medical condition of the patient, information identifying medication and a dosage of the medication, information identifying a date and/or a time when the medication was provided to the patient, information identifying a period of time for taking the medication, and/or the like. In some implementations, server 220 may provide, via the interface, information indicating a likelihood of fraud for each of the prescriptions. In some implementations, the interface may include an option to submit information indicating prescription fraud. In some implementations, the interface may include an option to create prescription information.

Process 500 may include determining whether potential prescription fraud has been detected (block 525). For example, server 220 may determine whether fraud information indicating potential prescription fraud has been received from medical personnel device 240 after providing the prescription history to medical personnel device 240. In some implementations, server 220 may provide an interface that may enable the medical personnel member to provide an assessment regarding potential prescription fraud based on the prescription history. For example, server 220 may provide the interface based on detecting selection of the option to submit the information indicating the prescription fraud.

By way of example, medical personnel device 240 may determine that the prescription the medical personnel member was planning on issuing (e.g., after identifying a medical condition of the patient) is the same as a prescription for a medication identified in the prescription history and determine that the prescription, identified in the prescription history, was issued by another medical personnel member within a certain amount of time (e.g., days, weeks, etc.) that is less than a prescribed amount of time for refilling the prescription or taking the medication. Accordingly, medical personnel device 240 may determine that the patient is attempting to commit fraud. In some implementations, medical personnel device 240 may determine, based on the prescription history, that the medication identified by the prescription was not provided. Accordingly, medical personnel device 240 may determine that the patient is not attempting to commit fraud.

Additionally, or alternatively, medical personnel device 240 may identify, in the prescription history, information indicating that the patient has previously committed prescription fraud or information indicating that a potential fraud has been previously detected for a prescription (e.g., similar prescription) issued to the patient. Additionally, or alternatively, medical personnel device 240 may determine that a level of the likelihood of fraud for one or more of the prescriptions, identified in the prescription history, exceeds a threshold level of likelihood of fraud. Accordingly, medical personnel device 240 may determine that the patient is attempting to commit fraud. Therefore, the medical personnel member may submit to server 220, using medical personnel device 240 and via the interface, fraud information indicating that the patient is attempting to commit fraud. The fraud information may include details regarding the assessment and a reason for submitting the fraud information as explained above. In some implementations, server 220 may store the fraud information, in a data structure, such as data structures 400A and 400B. In some implementations, medical personnel member may perform the acts described above with respect to medical personnel device 240.

When potential prescription fraud has been detected (block 525—YES), process 500 may include transmitting a notification of potential prescription fraud (block 530). For example, server 220 may transmit the notification of potential prescription fraud when the fraud information is received. In some implementations, the notification may include the fraud information, a date and/or time when the fraud information was received, information identifying the medical personnel member, information identifying the patient, information identifying the prescription (e.g., information identifying medication, a dosage of the medication, a quantity of refills of the prescription, a quantity of the medication, etc.), etc.

In some implementations, server 220 may transmit the notification to an insurance company of the patient, a medication provider of the patient, a government agency, and/or the like. For example, server 220 may search data structure 400A and/or 400B for contact information the insurance company, the medication provider, and the government agency and may transmit the notification via an e-mail, via a fax, via a telephone, via a text message, and/or the like. In some implementations, server 220 may store information identifying the notification in a data structure. For example, server 220 may store information identifying the notification and content of the notification in data structure 400B. As used herein, “government agency” may include a local government agency, a national government agency, an international government agency, a law enforcement agency, and/or the like.

When potential prescription fraud has not been detected (block 525—NO), process 500 may include receiving a request to create a prescription (block 535). For example, server 220 may receive a request to create a prescription for the patient, from medical personnel device 240, after providing the prescription history to medical personnel device 240. In some implementations, server 220 may receive the request based on detecting selection of the option to create the prescription information. In some implementations, server 220 may receive the request for the prescription history of the patient as part of the request to create the prescription for the patient.

Process 500 may include receiving information for a prescription (block 540). For example, server 220 may receive prescription information for the prescription from medical personnel device 240. In some implementations, server 220 may provide an interface, to medical personnel device 240, that may enable the medical personnel member to provide the prescription information and may receive the prescription information via the interface. For example, the medical personnel member may provide the prescription information for the prescription and may select an option of the interface to submit the information for the prescription. By way of example, the prescription information may include information identifying the medical personnel member, information identifying the patient, information identifying medication, information identifying a dosage for the medication, information identifying a period of time for taking the medication, information identifying a refill of the prescription, information identifying a medication provider for the medication, information identifying a current date and/or time, and/or the like. In some implementations, a portion of the prescription information may be automatically (i.e., without user intervention) provided by the interface. For example, server 220 may provide, via the interface, the information identifying the medical personnel member, the patient, the current date and/or time, and/or the like.

Process 500 may include determining whether to create the prescription (block 545). For example, server 220 may determine whether to create the prescription based on the prescription history of the patient, the prescription information, information regarding the patient, and/or information regarding the medical personnel member. In some implementations, server 220 may analyze information regarding prescriptions issued by the medical personnel member. For example, server 220 may search data structure 400A to determine whether data structure 400A includes information that indicates whether a potential fraud has been detected for a prescription issued by the medical personnel member. By way of example, server 220 may search data structure 400A to identify information that indicates that a potential prescription fraud has been detected for a particular prescription previously issued (e.g., within some threshold period of time) by the medical personnel member and server 220 may determine that information regarding the particular prescription is similar to the information regarding the prescription. For example, server 220 may determine that the information regarding the particular prescription and the information regarding the prescription include information identifying the same medication, the same dosage of the medication, the same quantity of refills of the particular prescription, and/or the same quantity of the medication of the prescription being issued shortly after the particular prescription was issued. Additionally, or alternatively, server 220 may search data structure 400A to determine a level of the likelihood of fraud for prescription(s) issued by the medical personnel member.

In some implementations, server 220 may analyze information regarding the patient. For example, server 220 may search data structure 400B to determine whether data structure 400B includes information indicating potential prescription fraud has been detected with respect to the patient. By way of example, server 220 may search data structure 400B to identify information indicating that the patient has attempted to commit or has committed potential prescription fraud or information indicating that the patient has been the victim of prescription fraud. In some implementations, server 220 may determine whether to create the prescription based on a level of match between the prescription information and the information regarding the prescriptions identified in the prescription history and periods of time between when the prescriptions were issued and when the information regarding the prescription was provided by the medical personnel member. By way of example, server 220 may identify a period of time that is less than a typical period of time between issuing prescriptions and may identify a match with respect to medication, with respect to dosage of the medication, with respect to quantity of refills of a prescription identifying the medication, with respect to a quantity of the medication, and/or the like. Additionally, or alternatively, server 220 may search data structure 400A to determine a level of the likelihood of fraud for prescription(s) issued to the patient.

In some implementations, server 220 may compare the prescription information to information regarding the prescriptions identified in the prescription history. For example, server 220 may compare the medication identified in the prescription information to medication identified in the prescription history of the patient. Additionally, or alternatively, server 220 may compare the dosage of the medication, identified in the prescription information, to the dosage of the medication identified in the prescription history of the patient.

Additionally, or alternatively, server 220 may compare a current date and/or time to a date and/or time the medication identified in the prescription history was provided. Additionally, or alternatively, server 220 may compare a current date and/or time to a date and/or time the prescription (identifying the medication) was issued. By way of example, server 220 may determine whether the medication was issued within a particular amount of time relative to the current date and/or time. Additionally, or alternatively, server 220 may compare a current date and/or time to a period of time for taking the medication identified in the prescription history.

For example, server 220 may determine that the medical personnel member and/or the patient may be attempting to commit prescription fraud when a portion or an entirety of the prescription information is similar to or matches a corresponding portion or an entirety of information regarding a corresponding prescription identified in the prescription history (e.g., same medication, same dosage of medication, same quantity of prescription refills, same quantity of medication, and/or the like) and when the prescription information is received within a period of time that is less than a typical period for refilling the corresponding prescription. In some implementations, when the prescription information is similar to the information regarding the corresponding prescription, server 220 may determine that the medical personnel member and/or the patient may not be attempting to commit prescription fraud when the prescription history indicates that the medication, identified in the information regarding the corresponding prescription, has not been provided to the patient.

When the prescription is to not be created (block 545—NO), process 500 may include transmitting a notification of potential prescription fraud (block 550). For example, server 220 may transmit the notification of potential prescription fraud based on a request to create the prescription and based on prescription fraud being detected. In some implementations, the notification may include the information indicating that the patient and/or the medical personnel member may be attempting to commit prescription fraud, a current date and/or time, information identifying the medical personnel member, information identifying the patient, the prescription information (e.g., the medication, the dosage, the quantity of refills of the prescription, the quantity of the medication, etc.), and/or the like.

In some implementations, server 220 may transmit the notification to a group of recipients in manner similar to the manner described herein with respect to block 530. For example, server 220 may transmit the notification to an insurance company of the patient, a medication provider of the patient, a government agency, an agency dealing with fraud of medical personnel members, a medication provider, the patient (if server 220 determines that the patient is not attempting to commit fraud), the medical personnel member (if server 220 determines that the medical personnel member is not attempting to commit fraud), and/or the like. For example, server 220 may transmit the notification to via e-mail, via fax, via telephone, via text messaging, etc.

When the prescription is to be created (block 545—YES), process 500 may include creating the prescription (block 555). For example, server 220 may create the prescription based on determining that potential fraud was not detected in connection with creating the prescription. By way of example, server 220 may create the prescription based on determining that neither the medical personnel member nor the patient is attempting to commit prescription fraud. In some implementations, as part of creating the prescription, server 220 may generate prescription information using the prescription information received from the medical personnel member. For example, server 220 may generate the prescription information to include the information regarding the prescription. Additionally, or alternatively, the prescription information may include information identifying the patient, information identifying the medical personnel member, information identifying a medication provider, information identifying a next medical personnel appointment of the patient, biometric information of the patient, and/or the like. In some implementations, server 220 may cause the prescription information to be stored in a data structure such as data structure 400A and/or data structure 400B.

Process 500 may include encoding the prescription (block 560, FIG. 5B). For example, server 220 may encode the prescription information, based on various encoding and/or encryption techniques, to generate encoded prescription information. In some implementations, server 220 may encode the prescription information, using a QR encoding technique, to generate a prescription information QR code. In some implementations, server 220 may encode information relating to a medical card for the patient and/or a prescription card for the patient to generate encoded medical card information and/or encoded prescription card information, and may store the encoded medical card information and/or the encoded prescription card information in a data structure. For example, server 220 may search data structure 400A and 400B to identify the information relating the medical card and/or the prescription card. Server 220 may encode the information relating to the medical card and/or the prescription card to generate the encoded medical card and/or the encoded prescription card. By way of example, server may encode the medical card and/or the prescription card using a QR encoding technique to generate a medical card QR code and/or a prescription card QR code as the encoded medical card and/or the encoded prescription card. In some implementations, server 220 may cause the encoded prescription information, the encoded medical card information, and/or the encoded prescription card information to be stored in a data structure such as data structure 400B. In some implementations, server 220 may cause the encoded medical card information and/or the encoded prescription card information to be transmitted to a group of entities. For example, server 220 may cause the medical card QR code and/or the prescription card QR code to be transmitted to an insurance company of the patient (e.g., to insurance company device 260).

Process 500 may include transmitting the prescription (block 565). For example, server 220 may cause the prescription information and/or the encoded prescription information to be transmitted to user device 210 and/or medication provider device 250. In some implementations, server 220 may cause the encoded prescription information to be transmitted to user device 210. For example, server 220 may transmit the encoded prescription information to a telephone number associated with user device 210, to a network address (e.g., an Internet Protocol (“IP”) address) associated with user device 220, to a fax number associated with user device 210, to an e-mail address associated with the patient, and/or the like. In some implementations, server 220 may cause the encoded prescription information to be transmitted to user device 210 via medical personnel device 240. For example, server 220 may cause the encoded prescription information to be presented via a display of medical personnel device 240 (or another device associated with the medical personnel member), and may enable user device 210 to scan the encoded prescription information from the display.

In some implementations, server 220 may cause the prescription information and/or the encoded prescription information to be transmitted to medication provider device 250. For example, server 220 may transmit the prescription information and/or the encoded prescription information to a telephone number associated with medication provider device 250, to a network address (e.g., an IP address) associated with medication provider device 250, to a fax number associated with medication provider device 250, to an e-mail address associated with the medication provider, and/or the like. Additionally, or alternatively, server 220 may transmit biometric information of the patient to medication provider device 250. The biometric information may enable a medication provider to authenticate the identity of the patient when the patient requests that the prescription be filled. In some implementations, server 220 may cause medical personnel device 240 to transmit the prescription information and/or the encoded prescription to medication provider device 250.

Process 500 may include transmitting a notification regarding the transmission of the prescription (block 570). For example, server 220 may transmit a notification indicating that the prescription information and/or the encoded prescription information has been transmitted to user device 210 and to medication provider device 250. In some implementations, the notification may include information identifying the patient, information identifying user device 210, information identifying the medical personnel member, information identifying the medication provider, information identifying a date and/or time of the patient visiting the medical personnel member, the prescription information, and/or the encoded prescription information. The information identifying user device 210 may enable a recipient of the notification to identify a device that was used to obtain the prescription.

In some implementations, server 220 may transmit the notification to an insurance company of the patient. For example, server 220 may transmit the notification to a telephone number associated with insurance company device 260, to a network address (e.g., an IP address) associated with insurance company device 260, to a fax number associated with insurance company device 260, and/or the like. Additionally, or alternatively, server 220 may transmit the notification to an e-mail address associated with the insurance company.

In some implementations, server 220 may transmit the notification to the patient. For example, server 220 may transmit the notification to an e-mail address of the patient, to a telephone number of the patient, to a fax number associated with the patient, to a device of the patient (other than user device 210), and/or the like. In some implementations, server 220 may transmit, to the patient, another notification that includes the information identifying user device 210. In some implementations, server 220 may transmit the notification to the medical personnel member. For example, server 220 may transmit the notification to an e-mail address of the medical personnel member, to a telephone number of the medical personnel member, to a fax number associated with the medical personnel member, to a device of the medical personnel member (other than medical personnel device 240), and/or the like.

Process 500 may include determining whether potential prescription fraud has been detected (block 575). For example, server 220 may determine whether fraud information indicating potential prescription fraud has been received after transmitting the notification indicating that the prescription information and/or the encoded prescription has been transmitted. In some implementations, server 220 may determine whether the fraud information has been received from the patient. For example, server 220 may receive fraud information from the patient and the fraud information may indicate that the patient did not visit the medical personnel member and/or did not receive the prescription. In some implementations, server 220 may determine whether the fraud information has been received from the medical personnel member. For example, server 220 may receive fraud information from the medical personnel member and the fraud information may indicate that the medical personnel member did not examine the patient and/or indicate that the medical personnel member did not issue the prescription corresponding to the prescription information. In some implementations, the fraud information may indicate that the medical personnel member did issue the prescription and may indicate that the medical personnel member has identified some discrepancies in the information identifying the prescription included in the notification. For example, the fraud information may identify a difference with respect to the quantity of medication, a difference with respect to the dosage of the medication, a difference with respect to the quantity of refills, and/or the like.

When the potential prescription fraud is detected (block 575—YES), process 500 may include transmitting a notification of potential prescription fraud (block 580). For example, server 220 may transmit the notification of potential prescription fraud when the fraud information is received. In some implementations, the notification may include information indicating that the patient and/or the medical personnel member may be attempting to commit prescription fraud, a date and/or time when the fraud information was received, information identifying the medical personnel member, information identifying the patient, information identifying the prescription, and/or the like.

In some implementations, server 220 may transmit the notification to a group of recipients that includes an insurance company of the patient, a medication provider of the patient, a government agency, and/or the like. For example, server 220 may search data structures 400A and 400B for contact information of the group of recipients. Server 220 may transmit, based on the contact information, the notification via e-mail, via fax, via telephone, and/or the like.

When the potential prescription fraud is not detected (block 575—NO), process 500 may end.

Although FIGS. 5A and 5B show example blocks of process 500, in some implementations, process 500 may include additional blocks, different blocks, fewer blocks, and/or differently arranged blocks than those depicted in FIGS. 5A and 5B. Additionally, or alternatively, one or more of the blocks of process 500 may be performed in parallel.

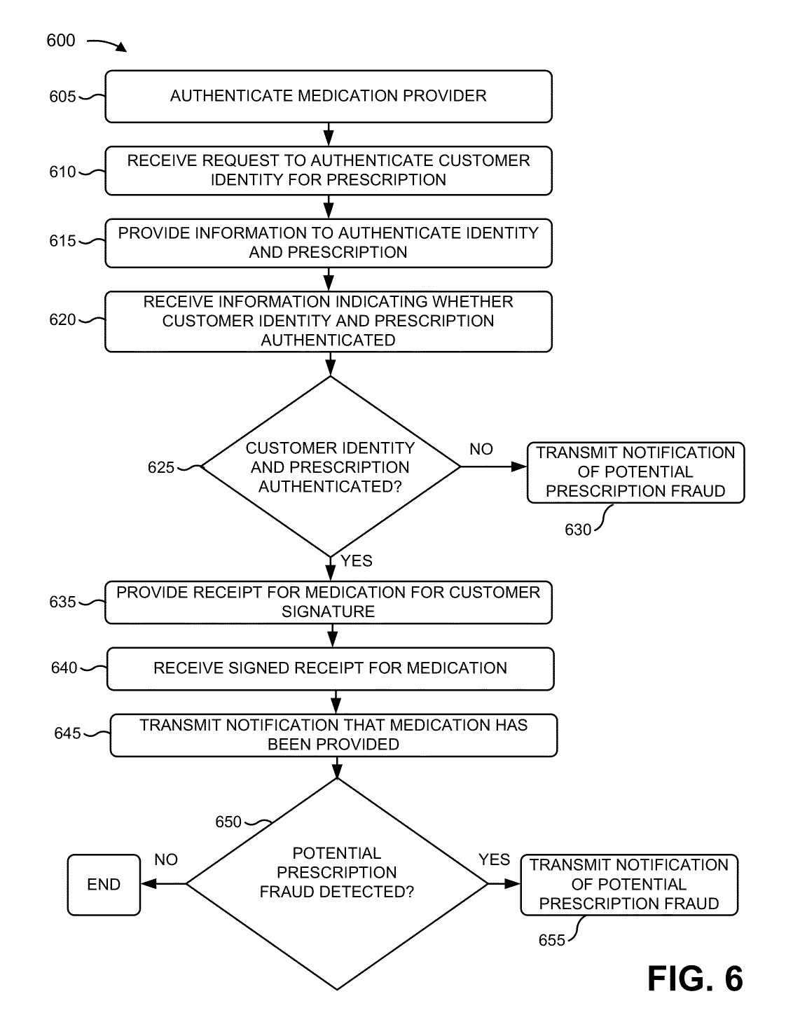

FIG. 6 is a flowchart of an example process 600 for monitoring the issuance of medication and detecting fraud related to prescriptions. In some implementations, process 600 may be performed by server 220. In some implementations, one or more blocks of process 600 may be performed by one or more devices (e.g., medication provider device 250) instead of, or possibly in conjunction with, server 220.

Process 600 may include authenticating a medication provider (block 605). For example, server 220 may receive information identifying the medication provider and authenticate the medication provider based on the information identifying the medication provider. In some implementations, server 220 may provide to the medication provider, via medication provider device 250, an interface that may enable the medication provider to log in to server 220 to determine whether to provide medication to a customer. For example, server 220 may provide an interface to medication provider device 240 that may enable the medication provider to enter a username and a password to access server 220. By way of example, server 220 may receive the username and the password and authenticate the medication provider based on the username and the password. In some implementations, after server 220 has authenticated the medication provider, server 220 may provide, to medication provider device 250, an interface that includes prescription information and encoded prescription information (e.g., prescription information QR code), associated with a plurality of patients, that server 220 has previously transmitted to medication provider device 250.

Process 600 may include receiving a request to authenticate an identity of a customer for a prescription presented by the customer (block 610). For example, server 220 may receive a request to authenticate the identity of the customer after authenticating the medication provider. In some implementations, server 220 may receive the request based on the medication provider selecting information included in prescription information or encoded prescription information, associated with the customer, that server 220 previously transmitted to medication provider device 240.

For example, medication provider device 250 may obtain information identifying a particular prescription from user device 210 of the customer. By way of example, medication provider device 250 may read encoded prescription information (e.g., QR code corresponding to the particular prescription) presented by a display of user device 210 of the customer to obtain particular prescription information. Alternatively, or additionally, medication provider device 250 may obtain the particular prescription information based on the customer submitting, via a web-based interface, information to request the filling of the particular prescription. Alternatively, or additionally, medication provider device 250 may obtain the particular prescription information based on the customer submitting, via a telephone call, information to request the filling of the particular prescription.

The medication provider may select prescription information, corresponding to the particular prescription information, from the interface that includes the prescription information and encoded prescription information previously transmitted by server 220. Medication provider device 250 (and/or the medication provider) may compare the particular prescription information with the selected prescription information to authenticate the identity of the customer and the particular prescription. The medication provider may select a reference (e.g., a link) included in the selected prescription information if the medication provider determines that additional information is required to authenticate the customer. Server 200 may receive the request based on the medication provider selecting the link. In some implementations, the request may include the prescription information received from server 220, information identifying the customer, information identifying user device 210 of the customer, information identifying a date and/or time the prescription was issued, information identifying content of the prescription (e.g., medication, dosage, refill, etc.).

Process 600 may include providing information to authenticate the identity of the customer and the particular prescription (block 615). For example, server 220 may provide authentication information to medication provider device 250 to enable the medication provider to authenticate the identity of the customer and the particular prescription. In some implementations, server 220 may search a data structure to identify the authentication information. For example, server 220 may perform a search of data structures 400A and 400B, using the information included in the request, to identify the authentication information. By way of example, the authentication information may include information identifying a medical personnel member that issued the selected prescription, biometric information of the patient associated with the selected prescription, and/or other types of information that may be used to authenticate the identity of the customer and the selected prescription. The information identifying the medical personnel member may include contact information of the medical personnel member including an office telephone number of the medical personnel member, a mobile telephone number of the medical personnel member, an e-mail address of the medical personnel member, and/or the like. In some implementations, server 220 may detect a capability of medication provider device 250 and transmit, based on the capability, only the portion of the biometric information that is supported by medication provider device 250.

In some implementations, server 220 may provide an interface, to medication provider device 240, that includes the authentication information. For example, the interface may include one or more telephone numbers of the medical personnel member and an e-mail address of the medical personnel member. When medication provider device 250 detects selection of a particular telephone number, medication provider device 250 may dial the particular telephone number and enable the medication provider to communicate with the medical personnel member to authenticate the identity of the customer. When medication provider device 250 detects selection of an e-mail address, medication provider device 250 may initiate an e-mail message of an e-mail application. The e-mail message may automatically be addressed to the e-mail address and may automatically include information identifying the prescription, information identifying the customer, information identifying a date and/or time of the customer contacting the medication provider to fill the prescription, and/or the like.

In some implementations, the interface may include an option to indicate whether the identity of the customer and the prescription have been authenticated.

Process 600 may include receiving information indicating whether the identity of the customer and the particular prescription have been authenticated (block 620). For example, server 220 may receive authentication result information indicating whether the identity of the customer and the prescription have been authenticated after providing the authentication information to medication provider device 250. In some implementations, server 220 may receive the authentication result information, based on the medication provider selecting the option to indicate whether the identity of the customer and the prescription have been authenticated. For example, server 220 may receive, from medication provider device 250, the authentication result information indicating that the identity of the customer and the prescription have been authenticated. In some implementations, server 220 may receive, from medication provider device 250, the authentication result information indicating that the identity of the customer and the prescription have not been authenticated.

Process 600 may include determining whether the identity of the customer and the particular prescription have been authenticated (block 625). For example, server 220 may determine whether the authentication result information indicates that the identity of the customer and the prescription have been authenticated or indicates that the identity of the customer and/or the prescription have not been authenticated.

When the identity of the customer and the particular prescription have not been authenticated (block 625—NO), process 600 may include transmitting a notification of potential prescription fraud (block 630). For example, server 220 may transmit the notification of potential prescription fraud when the authentication result information indicates that the identity of the customer and/or the prescription have not been authenticated. In some implementations, the notification may include information indicating that the patient and/or the medical personnel member may be attempting to commit prescription fraud, a date and/or time when the authentication result information was received, information identifying the medical personnel member, information identifying the patient, information identifying the particular prescription, and/or the like. In some implementations, server 220 may transmit the notification to a group of entities in a manner similar to the manner described herein with respect to block 580.

For example, server 220 may transmit the notification to an insurance company of the patient, a government agency, and/or the like. Additionally, or alternatively, server 220 may transmit the notification to the patient and/or the medical personnel member as appropriate. By way of example, server 220 may transmit the notification to the patient and the medical personnel member when server 220 determines, based on the authentication result information, that the customer is not the patient. Additionally, or alternatively, server 220 may transmit the notification to the patient when server 220 determines, based on the authentication result information, that the medical personnel member is attempting to commit fraud.

When the identity of the customer and the particular prescription have been authenticated (block 625—YES), process 600 may include providing a receipt for medication for the signature of the customer (block 635). For example, server 220 may determine that the authentication result information indicates that the identity of the customer and the prescription have been authenticated and may cause a receipt for the medication, identified by the selected prescription, to be provided to user device 210 of the customer. In some implementations, server 220 may cause medication provider device 240 to provide, to user device 210, an interface including information identifying the receipt for signature of the customer. For example, the interface may be provided to user device 210 based on the information identifying user device 210 that is included in the request to authenticate the identity of the customer for the prescription. By way of example, the interface may include information regarding the selected prescription, an option for the customer to sign the receipt, and an option for the customer to submit the signed receipt. The information regarding the selected prescription may include information identifying the patient, a current date and/or time, information identifying the medical personnel member, information identifying the selected prescription, information identifying the medication and a dosage of the medication, information identifying the medication provider, information identifying the insurance company of the patient, and/or the like. In some implementations, server 220 may provide the interface to user device 210.

Process 600 may include receiving the signed receipt for the medication (block 640). For example, server 220 may receive the signed receipt for the medication from user device 210 of the customer based on the customer selecting the option for the customer to submit the signed receipt. In some implementations, the signed receipt may include the information regarding the selected prescription, information identifying the signature of the customer, information identifying a date and/or time the receipt was signed, and/or the like.

Process 600 may include transmitting a notification indicating that the medication has been provided to the customer (block 645). For example, server 220 may transmit the notification to the insurance company associated with the selected prescription, the medical personnel member that issued the selected prescription, the medication provider, the patient associated with the selected prescription, and/or the like. In some implementations, the notification may include a portion of or an entirety of the information included in the signed receipt. In some implementations, server 220 may update a data structure to indicate that the medication has been provided to the patient. In some implementations, server 220 may update a data structure to indicate that the medication has been provided. For example, server 220 may update data structure 400A to include a date and/or time the receipt was signed, a date and/or time when the signed receipt was received, and/or the like. In some implementations, server 220 may transmit the notification in manner similar to the manner described herein with respect to block 570. For example, the notification may be transmitted to the medical personnel member that issued the selected prescription, the patient, the insurance company of the patient, the medication provider, etc. By way of example, the notification may be transmitted via e-mail, via text messaging, via telephone, via fax, and/or the like.

Process 600 may include determining whether information indicating potential prescription fraud has been detected (block 650). For example, server 220 may determine whether fraud information indicating potential prescription fraud has been received after transmitting the notification. In some implementations, server 220 may determine whether the fraud information has been received in a manner similar to the manner described herein with respect to block 575. For example, server 220 may receive the fraud information from the patient (e.g., user device 210 of the patient) and the fraud information may indicate that the patient did not receive the medication. For example, server 220 may receive the fraud information from the medication provider (e.g., medication provider device 250) and the fraud information may indicate that the medication provider did not provide the medication.

When the information indicating potential prescription fraud has been detected (block 650—YES), process 600 may include transmitting a notification of potential prescription fraud (block 655). For example, server 220 may transmit the notification of potential prescription fraud when the fraud information is received. In some implementations, the notification may include information indicating that the patient, the medical personnel member, and/or the medication provider may be attempting to commit prescription fraud, a date and/or time when the fraud information was received, information identifying the medical personnel member, information identifying the patient, information identifying the prescription, information identifying the medication, information identifying a date and/or time the medication was provided to the patient, and/or the like.

In some implementations, server 220 may transmit the notification to a group of recipients that includes an insurance company of the patient, a government agency, the patient (if server 220 determines that the patient is not attempting to commit fraud), the medical personnel member (if server 220 determines that the medical personnel member is not attempting to commit fraud), the medication provider (if server 220 determines that the medication provider is not attempting to commit fraud), and/or the like. For example, server 220 may transmit the notification via e-mail, via fax number, via telephone, via text messaging and/or the like.

Although FIG. 6 shows example blocks of process 600, in some implementations, process 600 may include additional blocks, different blocks, fewer blocks, and/or differently arranged blocks than those depicted in FIG. 6. Additionally, or alternatively, one or more of the blocks of process 600 may be performed in parallel.

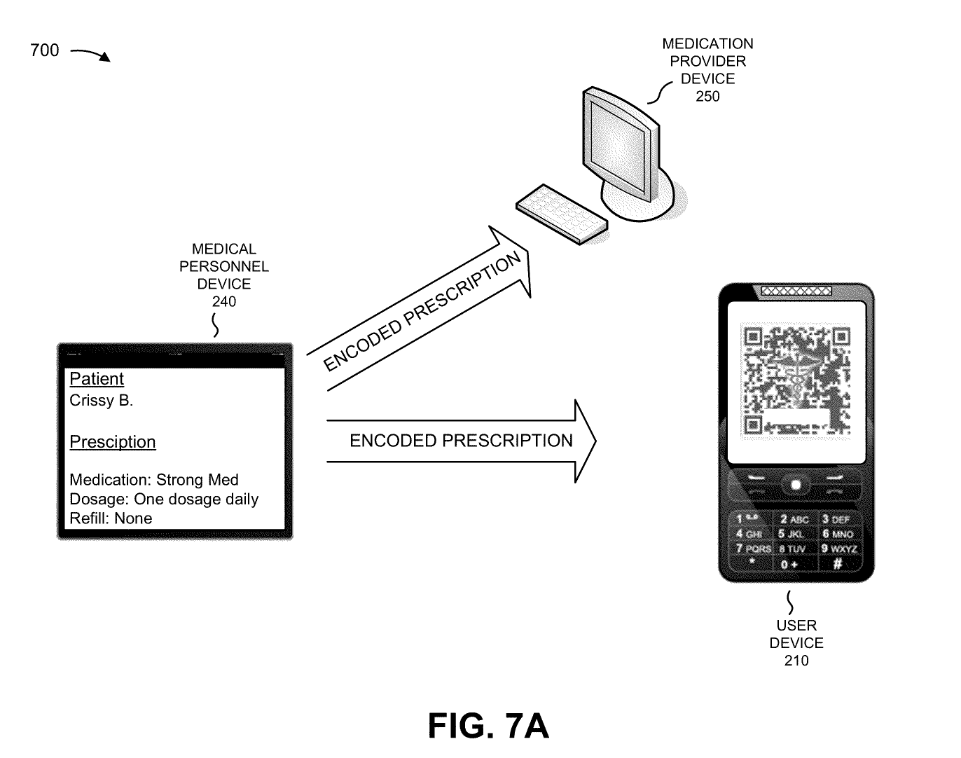

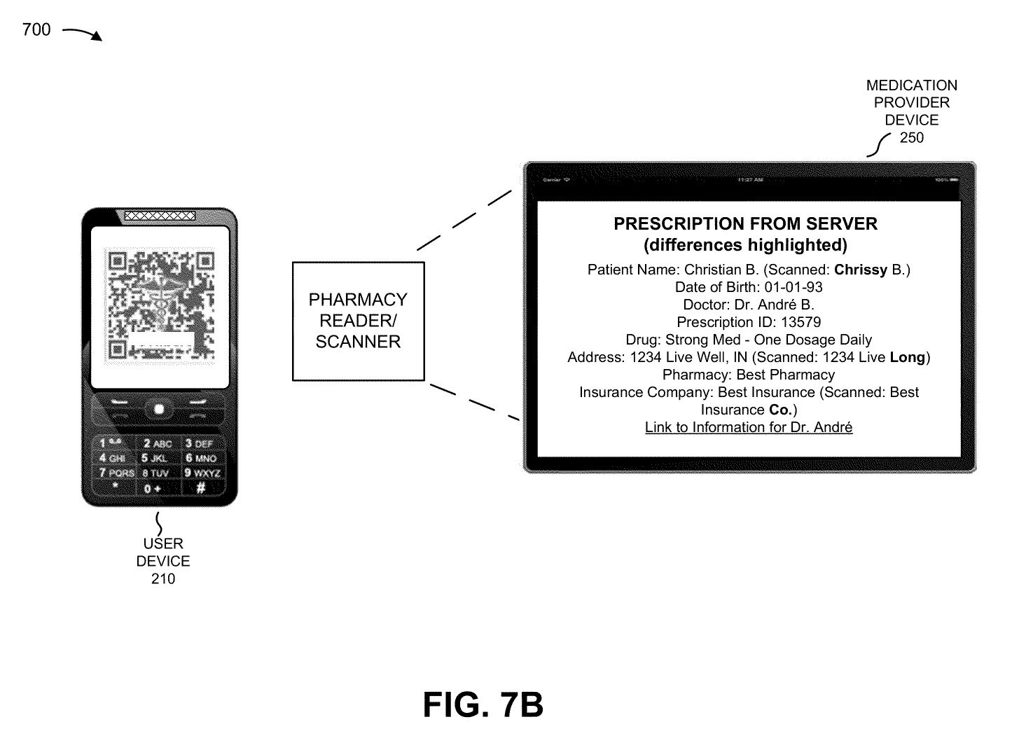

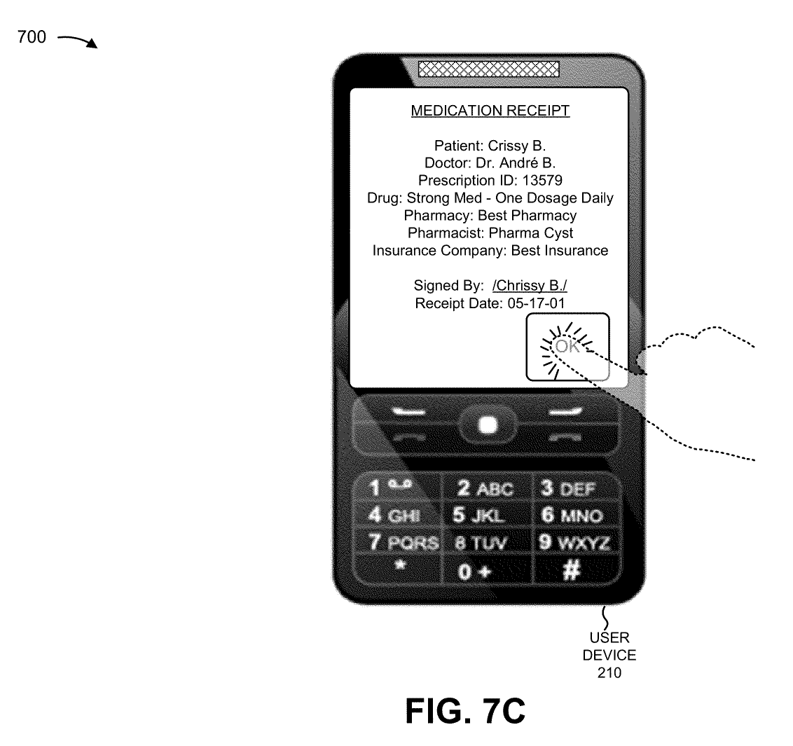

FIGS. 7A-7C are diagrams of an example 700 of process 500 and process 600 described above with respect to FIGS. 5A, 5B, and 6. In example 700, assume a patient (Chrissy B.) has visited a physician (Dr. André) regarding a medication condition. Further, assume the physician has diagnosed the medical condition and has identified medication for the patient. Further, assume the physician has logged in to server 220. As shown in relation to FIG. 7A, the physician has provided, via medical personnel device 240, prescription information that includes information identifying medication, a dosage of the medication, and a refill of the prescription. Assume the physician has submitted the prescription information to server 220. Further assume that server 220 (or medical personnel device 240) has encoded the prescription information to obtain encoded prescription information. As shown in relation to FIG. 7A, the prescription information may be encode to obtain a prescription information QR code. As also shown in relation to FIG. 7A, medical personnel device 240 may transmit the encoded prescription information to user device 210 of the patient and to medication provider device 250 of a pharmacy to enable the pharmacy to provide the medication to the patient.

As shown in relation to FIG. 7B, assume the patient has visited the pharmacy to request the filling of the prescription. Further assume the patient has presented user device 210 to a pharmacy reader/scanner for reading/scanning of the encoded prescription information presented by user device 210. As also shown in relation to FIG. 7B, the pharmacy reader/scanner may read the encoded information and may provide, to medication provider device 250, decoded prescription information corresponding to the encoded prescription information. Assume the pharmacist selects prescription information, corresponding to the decoded prescription information, from prescription information received from medical personnel device 240. Medication provider device 250 may compare the decoded prescription information to the selected prescription information. As also shown in relation to FIG. 7B, medication provider device 250 may present information that identifies differences between the decoded prescription information and the selected prescription information. As shown in relation to FIG. 7B, medication provider device 250 may include a link to information for Dr. André that the pharmacist may select to obtain additional information from Dr. André to validate the identity of the patient.

As shown in relation to FIG. 7C, assume the pharmacist has contacted Dr. André to confirm the patient name, the address, and the insurance company. Further, assume the pharmacist has authenticated the identity of the patient, after contacting Dr. André, and has provided the medication, identified by the decoded prescription, to the patient. As shown in relation to FIG. 7C, user device 210 of the patient may receive a medication receipt that includes information identifying the patient, the physician, the prescription, the medication, the pharmacy and pharmacist, and the insurance company of the patient. The medication receipt may be received from server 220 via medication provider device 250. The patient may sign the receipt and may select an option, included in the information regarding the medication receipt, to transmit the signed receipt. The signed receipt may be transmitted to server 220 and server 220 may cause a notification regarding the signed receipt to be transmitted.

Systems and methods, as described herein, may be able to monitor the prescriptions issued by the physician to determine whether the physician is attempting to commit a prescription fraud based on the physician logging in to server 220 prior to issuing prescriptions. Additionally, systems and methods, as described herein, may enable the physician to determine whether the patient is attempting to commit a prescription fraud by providing a prescription and medication history of the patient to the physician. Additionally, systems and methods, as described herein, may enable the patient and/or the physician to determine whether the patient and/or the physician are victims of a prescription and/or a medication fraud by transmitting notifications to the patient and the regarding prescriptions issued for the patient and/or regarding medications provided to the patient. Additionally, when a prescription and/or a medication fraud is detected, systems and methods, as described herein, may notify an appropriate government agency and the insurance company, and may notify the patient, the medical personnel member, and/or the medication provider as appropriate, thereby enabling appropriate remedial measures to be taken. As mentioned above, although examples of encoding information have been described herein with respect to using a QR encoding technique, the information described herein may be encoded using one or more other encoding and/or encryption techniques.

It will be apparent that example aspects, as described above, may be implemented in many different forms of software, firmware, and hardware in the implementations illustrated in the figures. The actual software code or specialized control hardware used to implement these aspects should not be construed as limiting. Thus, the operation and behavior of the aspects were described without reference to the specific software code—it being understood that software and control hardware could be designed to implement the aspects based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

No element, act, or instruction used in the present application should be construed as critical or essential unless explicitly described as such. Also, as used herein, the article “a” is intended to include one or more items and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device comprising:
a memory to store instructions; and
one or more processors to execute the instructions to:
receive, from a device of a medical personnel member, a request to generate a prescription for a patient and information regarding the prescription,
generate prescription information using the information regarding the prescription,
encode the prescription information to obtain encoded prescription information,
transmit the encoded prescription information to:
a device of a medication provider, and
a user device of the patient,
transmit a notification indicating that the encoded prescription information has been transmitted to the device of the medication provider and the user device,
the notification being transmitted to:
the device of the medical personnel member,
the user device, and
a device associated with an insurance company of the patient,
determine whether prescription fraud is detected, and
transmit another notification when the prescription fraud is detected,
the other notification indicating that the prescription fraud has been detected,
the other notification being transmitted to the device associated with the insurance company.

2. The device of claim 1, where the notification includes:
information identifying the medical personnel member,
information identifying the patient,
information identifying the medication provider,
the information regarding the prescription, and
information identifying at least one of a date or a time when the encoded prescription information was transmitted.

3. The device of claim 1, where, when encoding the prescription information, the one or more processors are to:
encode the prescription information to obtain a prescription information quick response (QR) code, and
where, when transmitting the encoded prescription, the one or more processors are to transmit the prescription information QR code.

4. The device of claim 1, where the one or more processors are further to:
identify a prescription history of the patient,
the prescription history including information regarding one or more prescriptions provided to the patient prior to receiving the request,
compare the information regarding the one or more prescriptions to the information regarding the prescription, and
where, when generating the prescription information, the one or more processors are to generate the prescription information based on comparing the information regarding the one or more prescriptions to the information regarding the prescription.

5. The device of claim 1, where, when transmitting the other notification, the one or more processors are to:
transmit the other notification to a device associated with a government agency relating to prescription fraud.

6. The device of claim 1, where the one or more processors are further to:
transmit, to the user device, an additional notification indicating that medication,
identified in the encoded prescription information, has been provided to the patient,
where, when determining whether the prescription fraud is detected, the one or more processors are to:
determine whether fraud information is received from the patient after transmitting the additional notification to the user device,
the fraud information indicating that the patient did not receive the medication, and
where, when transmitting the other notification, the one or more processors are to:
transmit the other notification when the fraud information is received,
the other notification further indicating that the medication provider is attempting to commit the prescription fraud.

7. The device of claim 1, where, when determining whether the prescription fraud is detected, the one or more processors are to:
determine whether fraud information is received from the medical personnel member after transmitting the notification to the device of the medical personnel member,
the fraud information indicating that the medical personnel member did not provide the information regarding the prescription, and
where, when transmitting the other notification, the one or more processors are to:
transmit the other notification when the fraud information is received,
the other notification being transmitted to the device associated with the insurance company and a device associated with a government agency relating to prescription fraud.

8. The device of claim 1, where the one or more processors are further to:
identify, in a data structure, prescription history of the patient,
the prescription history including information regarding one or more prescriptions provided to the patient by another medical personnel member prior to receiving the request, and
provide the prescription history to the device of the medical personnel member,
where, when receiving the request and the information regarding the prescription, the one or more processors are to receive the information regarding the prescription after providing the prescription history.

9. A method comprising:
receiving, by one or more processors and from a device of a medical personnel member, a request to generate a prescription for a user;
receiving, by the one or more processors and from the device, information regarding the prescription;
determining, by the one or more processors and based on the information regarding the prescription, whether prescription fraud is detected;
transmitting, by the one or more processors, a first notification when the prescription fraud is detected,
the first notification indicating that the prescription fraud is detected,
the first notification being transmitted to at least one of:
a device of a medication provider associated with the user, or
a device associated with an insurance company of the user;
generating, by the one or more processors, prescription information when the prescription fraud is not detected;
transmitting, by the one or more processors, the prescription information to:
the device of the medication provider, and
a first user device of the user;
transmitting, by the one or more processors, a second notification indicating that the prescription information has been transmitted to the device of the medication provider and the first user device,
the second notification being transmitted to:
the device of the medical personnel member,
a second user device of the user, and
the device associated with the insurance company.

10. The method of claim 9, further comprising:
encoding the prescription information to obtain encoded prescription information, where transmitting the prescription information includes:
transmitting the encoded prescription information to the device of the medication provider and the first user device.

11. The method of claim 10, where encoding the prescription information includes:
encoding the prescription information to obtain a prescription information quick response (QR) code, and
where transmitting the encoded prescription includes transmitting the prescription information QR code.

12. The method of claim 10, where the prescription identifies a medication, the method further comprising:
receiving, from the device of the medication provider, information indicating that the medication has been provided to the user; and
transmitting a third notification indicating that the medication has been provided to the user device,
the third notification being transmitted to:
the device of the medical personnel member,
the device associated with the insurance company, and
at least one of the first user device or the second user device.

13. The method of claim 12, where receiving the information indicating that the medication has been provided to the user includes:
receiving information regarding a receipt for the medication,
the receipt including information identifying a signature of the user.

14. The method of claim 12, where the information indicating that the medication has been provided to the user includes:
information identifying the medical personnel member,
information identifying the user,
information identifying the medication provider,
the information regarding the prescription,
information identifying at least one of a date or a time when the prescription information was transmitted, and
information identifying at least one of a date or a time when the information, indicating that the medication has been provided to the user, was received.

15. The method of claim 14, further comprising:
storing the information, indicating that the medication has been provided to the user, and the prescription information as part of a prescription history of the user.

16. A computer-readable medium storing instructions, the instructions comprising:
one or more instructions which, when executed by one or more processors, cause the one or more processors:
receive, from a device of a medical personnel member, information regarding a prescription for a patient;
generate prescription information using the information regarding the prescription;
transmit the prescription information to:
a device of a medication provider,
a user device of the patient,
transmit a notification indicating that the prescription information has been transmitted to the device of the medication provider and the user device,
the notification being transmitted to:
the device of the medical personnel member,
the user device, and
a device associated with an insurance company of the user,
determine whether prescription fraud has been detected; and
transmit another notification when the prescription fraud is detected,
the other notification indicating that the prescription fraud has been detected.

17. The computer-readable medium of claim 16, the instructions further comprising:
one or more instructions to encode the prescription information to obtain encoded prescription information,
where the one or more instructions to transmit the prescription information include one or more instructions to transmit the encoded prescription information to the device of the medication provider and the user device.

18. The computer-readable medium of claim 16, where the one or more instructions to determine whether the prescription fraud has been detected include:
one or more instructions to determine whether fraud information is received from the medical personnel member after transmitting the notification,
the fraud information indicating that the medical personnel member did not provide the information regarding the prescription, and
where the one or more instructions to transmit the other notification include:
one or more processors are to transmit the other notification when the fraud information is received,
the other notification being transmitted to at least one of the device associated with the insurance company or a device associated with a government agency relating to prescription fraud.

19. The computer-readable medium of claim 16, where the prescription information identifies a medication,
the instructions further comprising:
one or more instructions to receive information indicating that the medication has been provided to the user; and
one or more instructions to transmit a notification indicating that the medication has been provided to the user,
the notification, indicating that the medication has been provided to the user, being transmitted to:
the device of the medical personnel member,
the user device, and
the device associated with the insurance company.

20. The computer-readable medium of claim 19, where the information, indicating that the medication has been provided to the user, includes:
information identifying the medical personnel member,
information identifying the patient,
information identifying the medication provider,
the information regarding the prescription,
information identifying at least one of a date or a time when the prescription information was transmitted, and
information identifying at least one of a date or a time when the information, indicating that the medication has been provided to the user, was received.
